(19) United States
(12) Patent Application Publication
(10) Pub. No.: US 2020/0094681 A1
(43) Pub. Date: Mar. 26, 2020

(54) Electric Power Conversion Device and Method for Debugging the Same

(71) Applicant: Hitachi Automotive Systems, Ltd., Hitachinaka-shi, Ibaraki (JP)

(72) Inventors: Ryosuke YOKOYAMA, Hitachinaka-shi (JP); Yoshinobu FUNAZAKI, Hitachinaka-shi (JP); Ryutaro NAKAZATO, Hitachinaka-shi (JP)

(21) Appl. No.: 16/620,037

(22) PCT Filed: Apr. 20, 2018
(86) PCT No.: PCT/JP2018/016239

§ 371 Date: Dec. 6, 2019

(30) Foreign Application Priority Data
Jun. 7, 2017 (JP) 2017-112201

(51) Int. Cl. B60L 3/00; B60L 3/12; G06F 11/36; G06F 13/40; H04L 12/40

(52) U.S. Cl. CPC B60L 3/0084; B60L 3/003; B60L 3/12; H04L 2012/40215; G06F 13/4022; H04L 12/40; G06F 11/3664

(57) ABSTRACT

To achieve a balance between easiness and security such that a user can perform manipulation in easy environments when a debug mode, e.g., parameter correction, is activated and used.

A electric power conversion device according to the present invention includes a control portion that controls an inverter circuit portion and that is linked with an information control communication line, and a wire that links a resolver, which detects rotation of a rotor of a motor, with the control portion, wherein the control portion activates a debug mode that changes a program of the control portion on the basis of a debug start signal acquired via the information control communication line and the wire.

### TECHNICAL FIELD

The present invention relates to an electric power conversion device and a method for debugging the same.

### BACKGROUND ART

With the popularization of hybrid automobiles and electric automobiles, electrification and electronification of components of a vehicle have rapidly progressed. Main examples of the electronification of the vehicle components include an electric power conversion device for motor drive. For example, an electric power conversion device regarding an electric power steering device described in PTL 1 executes processing of correcting a detection signal of a resolver for detecting the rotation state of the motor.

By the way, when a debug mode for special operations such as parameter correction, software reprogramming, or an internal state analysis of the electric power conversion device is activated and used, easiness for a user to be capable of manipulation in easy environments is demanded. However, security for a configuration in an activation environment that cannot be assumed in normal use is also needed.

### CITATION LIST

### Patent Literature

PTL 1: 2011-097679 A

### SUMMARY OF INVENTION

### Technical Problem

It is an object of the present invention to achieve a balance between easiness and security such that a user can perform manipulation in easy environments when a debug mode, e.g., parameter correction, is activated and used.

### Solution to Problem

A electric power conversion device according to the present invention includes a control portion that controls an inverter circuit portion and that is linked with an information control communication line, and a wire that links a resolver, which detects rotation of a rotor of a motor, with the control portion, wherein the control portion activates a debug mode that changes a program of the control portion on the basis of a debug start signal acquired via the information control communication line and the wire.

Moreover, a method for debugging an electric power conversion device according to the present invention includes a first step in which an information control communication line that is linked with a control portion that controls an inverter circuit portion and a wire for linking a resolver, which detects rotation of a rotor of a motor, with the control portion are connected with a relay connection portion, a second step in which a debug start signal is transmitted to the control portion via the information control communication line and the wire, a third step in which a debug completion signal is received, a fourth step in which the relay connection portion is electrically shutoff from the information control communication line or the wire, and a fifth step in which a debug signal related to drive of the motor is transmitted to the control portion via the information control communication line (S306).

### Advantageous Effects of Invention

According to the present invention, both easiness and security when a debug mode, e.g., parameter correction, is activated and used can be achieved.

### BRIEF DESCRIPTION OF DRAWINGS

FIG. 1 is a system diagram illustrating a configuration of an automobile.

FIG. 2 is a circuit block diagram of an electric power conversion device 100 and a periphery thereof.

FIG. 3 is a detailed circuit block diagram of an electric power conversion device 100 and a periphery thereof according to the present embodiment.

FIG. 4 is a view of communication timing in a debug mode.

FIG. 5 is a flowchart corresponding to a procedure manual for a user using a debug mode.

FIG. 6 is an embodiment related to connection of a relay connection portion 113.

FIG. 7 is another embodiment related to connection of the relay connection portion 113.

FIG. 8 is a block diagram illustrating a facility environment during the debug operation described in FIG. 5.

### DESCRIPTION OF EMBODIMENTS

An example of the present invention is described below in conjunction with the drawings.

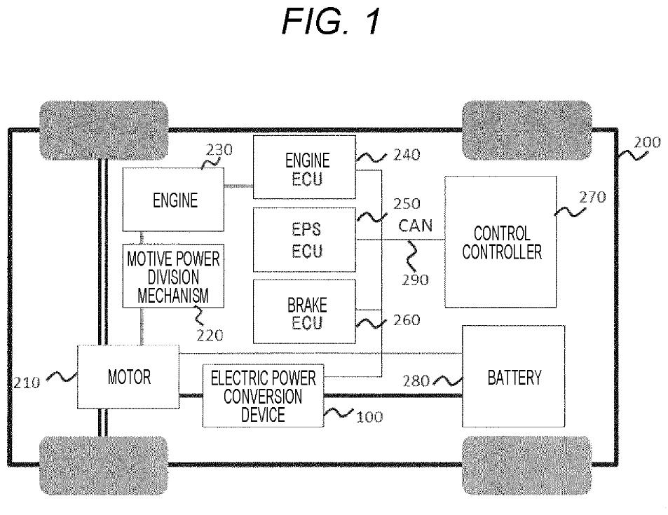

FIG. 1 is a system configuration diagram explaining a system of an HEV 200.

The HEV 200 is an automobile that travels when a motor 210 is rotated with the motive power of an engine 230 or an electric power conversion device 100.

The electric power conversion device 100 converts electric power supplied from a battery 280, supplies the converted electric power to a motor 210, and controls the motor 210 according to a torque command received from a control controller 270. The motor 210 is rotated with the motive power of the engine 230 or the electric power conversion device 100, and causes the HEV 200 to travel.

A motive power division mechanism 220 is a mechanism that, during rotation of the motor 210, connects the engine 230 to the motor 210 when the engine 230 is used as motive power, and separates the engine 230 from the motor 210 when the engine 230 is not used as motive power.

The engine 230 rotates the motor 210 under control by an engine ECU 240. The engine ECU 240 receives a command from the control controller 270 and controls the engine 230.

An EPS ECU 250 receives a command from the control controller 270 and controls electric steering. A brake ECU 260 receives a command from the control controller 270 and controls a brake.

The control controller 270 is a main control controller of the HEV 200 to transfer information bi-directionally through an information communication line 290 between the electric power conversion device 100, the motor 210, the engine ECU 240, the EPS ECU 250, the brake ECU 260, and the battery 280.

The battery 280 is a power source that supplies electric power, which is motive power for the motor 210, via the electric power conversion device 100.

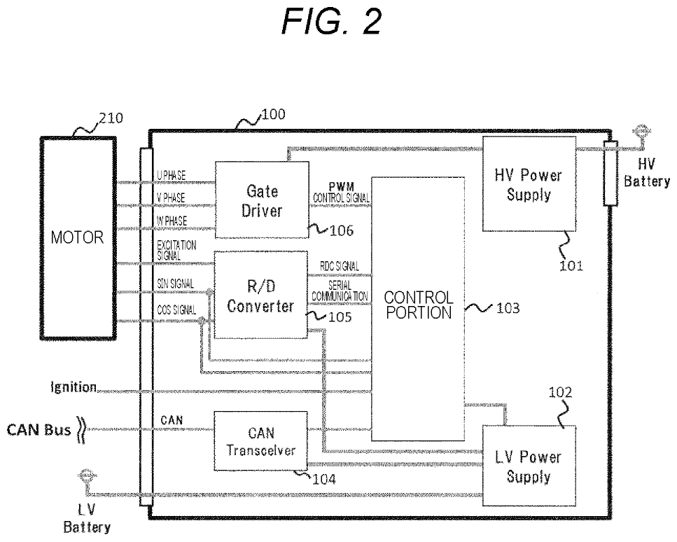

FIG. 2 is a circuit block diagram of the electric power conversion device 100 and a periphery thereof.

A high voltage power circuit portion 101 (HV Power Supply) is a power source portion that converts electric power supplied from the battery 280 to the electric power conversion device 100, and supplies the electric power to a gate drive circuit portion 106 (Gate Driver).

A low voltage power circuit portion 102 (LV Power Supply) is a power source portion that converts an electric power supplied from a low voltage power source (Low Volt Battery) of the HEV 200 to the electric power conversion device 100, and supplies the electric power to a control portion 103, a CAN transceiver 104 (CAN Transceiver), and an RD converter 105 (R/D Converter).

The control portion 103 is a control portion that performs current control by performing PWM control on the gate drive circuit portion 106 on the basis of motor angle information transferred to the RD converter 105 and a torque command given from the control controller 270 via the CAN transceiver 104.

The CAN transceiver 104 is a transceiving portion that transfers information to both control equipment linked with a bus of the information communication line 290 and the control portion 103.

The RD converter 105 sends an excitation signal to the motor 210, receives an SIN signal or COS signal excited in the motor 210, converts the signal to angular information, and transfers a digitized RDC signal to the control portion 103.

The gate drive circuit portion 106 is a driver portion that applies current to the motor 210 according to a PWM control signal from the control portion 103.

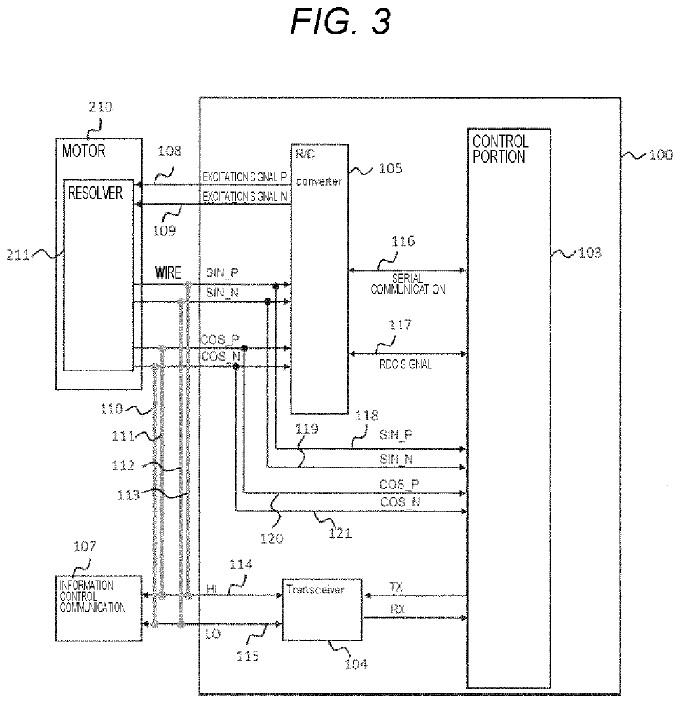

FIG. 3 is a detailed circuit block diagram of the electric power conversion device 100 and a periphery thereof according to the present embodiment.

An excitation signal_P 108 and an excitation signal_N 109; SIN_P 118 and SIN_N 119; COS_P 120 and COS_N 121; and Hi 114 and Lo 115 are paired to constitute differential signal wires.

The resolver 211 is an angle sensing portion that excites the SIN_P 118 and the SIN_N 119, and the COS_P 120 and the COS_N 121 according to the excitation signal_P 108 and the excitation signal_N 109 in the motor 210, and feeds back the angle information to the RD converter 105.

The SIN_P 118 and the SIN_N 119, and the COS_P 120 and the COS_N 121 are directly input not only to the RD converter 105, but also to the control portion 103, and are used as redundant sensing means in cases where the RD converter 105 is defective.

The relay connection portions 110 to 113 are not connected during normal operation in which the motor 210 rotates, but are connected only in a debug mode, e.g., software reprogramming, internal state analysis, an internal voltage parameter change, or the like of the electric power conversion device 100.

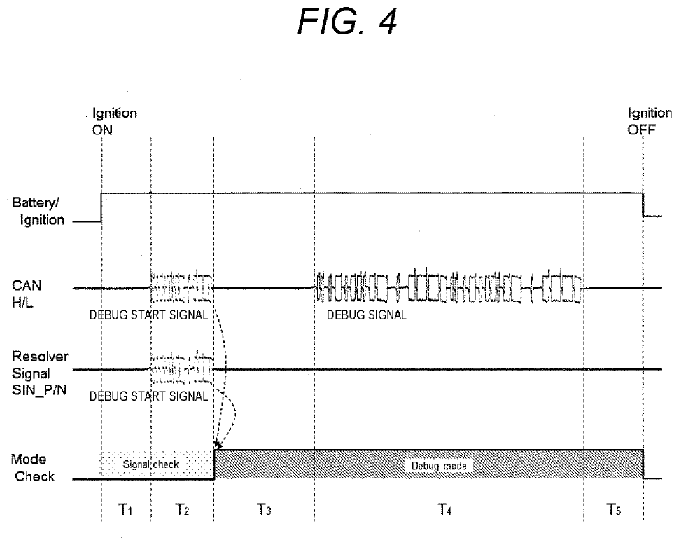

FIG. 4 is a view of communication timing in a debug mode.

The debug mode illustrated in FIG. 3 is a mode that is activated only when a debug start signal transmitted from information control communication 107 in T2 period is simultaneously input in a route in which the debug start signal is input to the control portion 103 via the Hi 114 and the Lo 115 and in a route in which the debug start signal is input to the control portion 103 via the SIN_P 118 and the SIN_N 119.

Note that, here, the SIN_118 and the SIN_N 119 are taken as an example, but, when the Hi 114 and the Lo 115 are used by being connected to the COS_P 120 and the COS_N 121, the debug mode can be similarly activated, and, alternatively, when the SIN_P 118 and the SIN_N 119, and the COS_P 120 and the COS_N 121 are simultaneously connected to the Hi 114 and the Lo 115, the debug mode can be similarly activated.

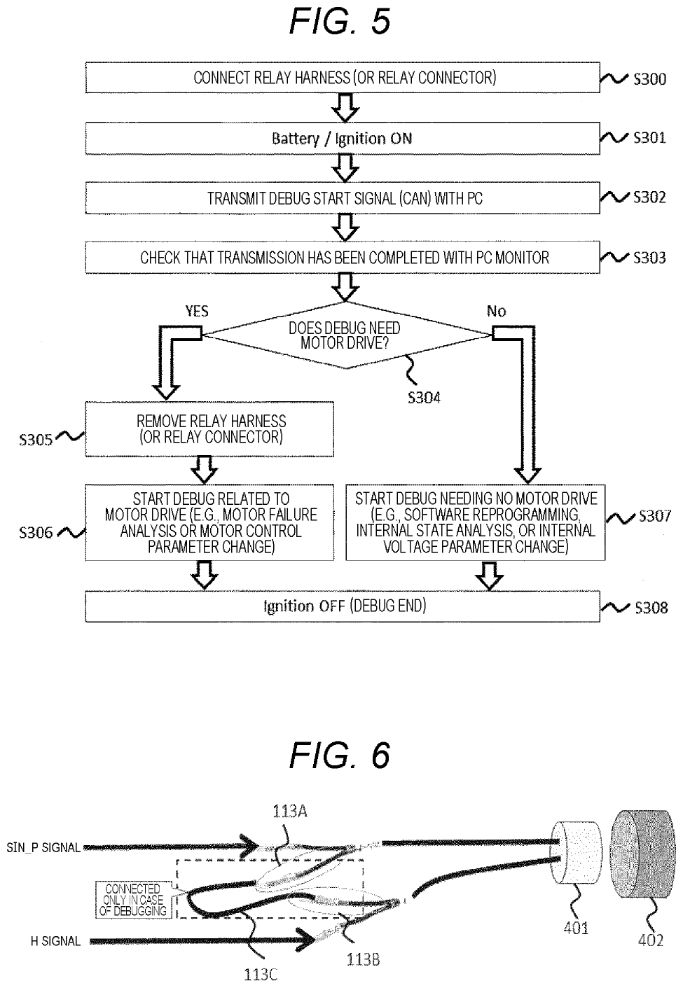

FIG. 5 is a flowchart corresponding to a procedure manual for a user using the debug mode. Note that an example of manipulation environments for use of the debug mode is illustrated in FIG. 8.

The user, first, connects a relay connection portion before turning on power (S300), transmits a debug start signal (S302), and checks that transmission has been completed (S303), the user determines whether to perform debug operation that requires motor drive (S304), and, when YES, it is necessary to remove the relay connection portion and start debugging (S305, S306), and, when No, the user can start debugging as it is (S307).

FIG. 6 is an embodiment related to connection of the relay connection portion 113.

A connector terminal portion 402 is a connection portion that is provided on an outer surface of the electric power conversion device 100 and into which a harness connector 401 including lines connected to the outside is inserted.

A relay connection portion 113A and a relay connection portion 113B are terminals that are provided to connect the SIN_P 118 and the Hi 114 in a relaying manner, and are connected to the relay line 113C to establish connection of the SIN_P 118 and the Hi 114.

Thus, outside the electric power conversion device 100, the user can connect one end and the other end of each of a plurality of signal lines of the harness connector 401 and can use the debug mode without having to disassemble the electric power conversion device 100 in use.

Note that, in FIG. 6, the relay connection portion 113 is taken as an example, but the same configuration can also be applied to the relay connection portions 110 to 112.

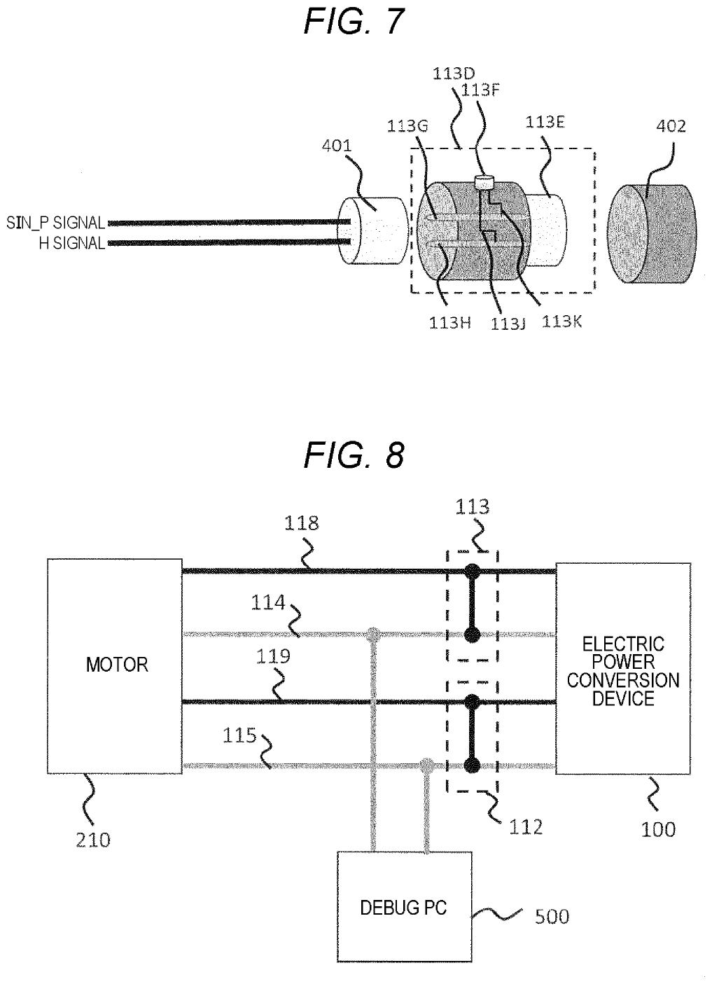

FIG. 7 is another embodiment related to connection of the relay connection portion 113. A relay connector 113D is an example of connection of the relay connection portion 113.

A connector pin 113G and a connector pin 113H are members for connecting the harness connector 401 to the connector terminal portion 402 when the harness connector 401 is inserted.

A switch 113F, when turned on, can connect a wire 113K and a wire 113J, and, when turned off, disconnect the wire 113K and the wire 113J. When the switch 113F is turned on, the SIN_P 118 and the Hi 114 can be connected in a relayed manner via the wire 113K and the wire 113J. In step S300 described in FIG. 5, the switch 113F is turned on and is used, and in step S305, the switch 113F is turned off and is used so as to enable debug operation.

When the relay connector 113D illustrated in FIG. 7 is interposed and used as a relay-connection means, the debug mode can be easily activated without making special effort on the connector terminal portion 402, the harness connector 401, and the wires the user usually uses.

Moreover, when the switch 113F is turned on, the operation can be performed with the debug mode being activated, and when the switch 113F is turned off and used during subsequent debugging, it can be used without having an adverse influence on debugging that is performed while the resolver 211 (motor 210) is driven.

Note that, in FIG. 7, the relay connection portion 113 is taken as an example, but the same configuration can be applied to the relay connection portions 110 to 112.

FIG. 8 is a block diagram illustrating a facility environment during the debug operation described in FIG. 5.

A debug PC 500 is connected to the Hi 114 and the Low 115, and can transmit a debug start signal to the electric power conversion device 100 and monitor a result of the transmission. The user can connect the relay connection portion 112 or the relay connection portion 113 to use the debug mode.

Note that different equipment, e.g., the control controller 270, which is linked with a bus, can be substituted and used for the debug PC 500.

When a debug mode for special operations such as parameter correction, software reprogramming, or an internal state analysis of the electric power conversion device 100 is activated and used, easiness for a user to be capable of manipulation in easy environments is demanded. However, security for a configuration in an activation environment that cannot be assumed in normal use is also needed.

As illustrated in FIG. 3, when the Hi 114 and the Lo 115 corresponding to the information control communication line, and the SIN_P 118, the SIN_N 119, the COS_P 120 and the COS_N 121 corresponding to the wires linking the resolver 211 and the control portion 103 are used in a relay-connection environment, the debug start signals flowing to the Hi 114 and the Lo 115 corresponding to the information communication line also pass through the SIN_P 118, the SIN_N 119, the COS_P 120, and the COS_N 121 linking the resolver 211 and the control portion 103, and the debug mode is activated only when the debug start signals are simultaneously input to the control portion 103.

When the debug mode is activated only with the debug start signals flowing in the information communication lines 114 and 115, the security is impaired, but the user can activate the debug mode easily and with high security only by inserting the relay connection portions 110 to 113.

### REFERENCE SIGNS LIST

100 electric power conversion device
101 high voltage power circuit portion
102 low voltage power circuit portion
103 control portion
104 CAN transceiver
105 RD converter
106 gate drive circuit portion
107 information control communication
108 excitation signal P
109 excitation signal N
110 relay connection portion
111 relay connection portion
112 relay connection portion
113 relay connection portion
113A relay connection portion
113B relay connection portion
113C relay line
113D relay connector
113F switch
113G connector pin
113H connector pin
113J wire
113K wire
114 Hi
115 Lo
116 serial communication
117 RDC signal
118 SIN_P
119 SIN_N
120 COS_P
121 COS_N
200 HEV
210 motor
211 resolver
220 motive power division mechanism
230 engine
240 engine ECU
250 EPS ECU
260 brake ECU
270 control controller
280 battery
290 information communication line
401 harness connector
402 connector terminal portion
500 debug PC

1. An electric power conversion device comprising:
a control portion configured to control an inverter circuit portion and be linked with an information control communication line; and
a wire configured to link a resolver configured to detect rotation of a rotor of a motor with the control portion,
wherein
the control portion activates a debug mode configured to change a program of the control portion on the basis of a debug start signal acquired via the information control communication line and the wire.

2. The electric power conversion device according to claim 1, comprising:
a housing configured to store the control portion;
a first connector configured to be provided at a part of the housing and connected to the control portion via the information control communication line; and
a second connector configured to be linked with a plurality of signal lines arranged outside of a storage space of the housing and connected to the first connector,
wherein
the wire has one end and an other end, which are respectively connected to any two of the plurality of signal lines.

3. The electric power conversion device according to claim 1, comprising:
a housing configured to store the control portion;
a first connector configured to be provided at a part of the housing and connected to the control portion via the information control communication line; and
a relay connector configured to be connected between a second connector configured to be linked with a plurality of signal lines arranged outside of a storage space of the housing and the first connector,
wherein
the relay connector includes a plurality of terminals connected to the plurality of signal lines and connected to the first connector, and
the wire has one end and an other end, which are respectively connected to any two of the plurality of terminals.

4. The electric power conversion device according to claim 3, comprising a switch portion configured to be connected to the wire, and shutoff or conduct a signal.

5. A method for debugging an electric power conversion device, comprising:
a first step in which an information control communication line configured to be linked with a control portion configured to control an inverter circuit portion and a wire for linking a resolver configured to detect rotation of a rotor of a motor with the control portion are connected with a relay connection portion,
a second step in which a debug start signal is transmitted to the control portion via the information control communication line and the wire,
a third step in which a debug completion signal is received,
a fourth step in which the relay connection portion is electrically shutoff from the information control communication line or the wire, and
a fifth step in which a debug signal related to drive of the motor is transmitted to the control portion via the information control communication line.
